(19) United States
(12) Patent Application Publication
(10) Pub. No.: US 2026/0318806 A1
(43) Pub. Date: Oct. 15, 2026

(54) SELF-CALIBRATING APPARATUS FOR MEASUREMENT OF AEROSOL ABSORPTION AND METHODS THEREFOR

(71) Applicant: National Research Council of Canada, Ottawa (CA)

(72) Inventors: Joel C. CORBIN, Ottawa (CA); Jalal NOROOZ OLIAEE, Gloucester (CA)

(21) Appl. No.: 19/484,789

(22) PCT Filed: May 15, 2024
(86) PCT No.: PCT/CA2024/050650

§ 371 Date: Nov. 14, 2025

Related U.S. Application Data
(60) Provisional application No. 63/466,911, filed on May 16, 2023.

(51) Int. Cl. G01N 15/075; G01N 21/27; G01N 21/39

(52) U.S. Cl. CPC G01N 15/075; G01N 21/274; G01N 21/39

(57) ABSTRACT

A method of calibrating measurement of aerosol absorption is provided. A pump beam capable of operating with at least two wavelengths is directed to overlap with a probe beam in a gas in a sample region, wherein the first pump beam wavelength overlaps with an absorption line of a gaseous species of the gas and the second pump beam wavelength does not. Resulting first and second photothermal signals are detected. A light absorption value of the gaseous species is determined based on the first photothermal signal and the second photothermal signal. The light absorption value is stored, for recalling in calibrating the measurement of aerosol absorption. A method of measuring aerosol absorption and a self-calibrating apparatus for measurement of aerosol absorption are also provided.

### CROSS-REFERENCE TO RELATED APPLICATION

The present patent application claims the benefit of U.S. Provisional Patent Application Serial No. 63/466911, entitled “Self-calibrating apparatus for measurement of aerosol absorption and methods therefor”, and filed on May 16, 2023, the entire contents of which are incorporated herein by reference.

### FIELD

The present disclosure relates to calibrating measurements of aerosol absorption. In particular, the disclosure relates to calibrating measurement of aerosol absorption in situ with a gas.

### BACKGROUND

Aerosols are a form of air pollution which may form as a by-product of combustion. They scatter and absorb incoming sunlight.

A number of techniques for measuring aerosol absorption have been proposed.

Filters can be used to capture and detect aerosol absorption using changes in light attenuation or transmission as a proxy thereof.

If photoacoustic spectroscopy is used, a modulated excitation source is applied to an aerosol, the aerosol is periodically heated, and a resulting acoustic wave is detected.

When photothermal interferometry is used a, possibly modulated, excitation source is applied to an aerosol, the aerosol becomes heated, and a change in interference signal is detected.

However, there is a need for traceably quantifying aerosol absorption.

### SUMMARY

According to an aspect of the disclosure, there is provided a method of calibrating measurement of aerosol absorption comprising: directing at least one pump beam to overlap with a probe beam in a gas in a sample region, wherein the at least one pump beam has a first wavelength that overlaps with an absorption line of a gaseous species of the gas, resulting in a first photothermal signal; directing the at least one pump beam to overlap with the probe beam in the gas in the sample region, wherein the at least one pump beam has a second wavelength that is off the absorption line, resulting in a second photothermal signal; detecting the first and second photothermal signals; determining a light absorption value of the gaseous species based on the first and second photothermal signals; and storing the light absorption value, for recalling in calibrating the measurement of aerosol absorption by a third photothermal signal.

In some embodiments, the first wavelength is on-resonance with an absorption peak of the gaseous species.

In some embodiments, the at least one pump beam has a linewidth that is sufficiently narrow, relative to an absorption linewidth of the gaseous species, to tune the at least one pump beam on or off the absorption line.

In some embodiments, the gaseous species is a narrow-band absorber having a known absorption cross-section.

In some embodiments, the gaseous species is diatomic oxygen.

In some embodiments, the detecting the first and second photothermal signals is based on interferometric detection or optical heterodyne detection.

In some embodiments, the determining the light absorption value of the gaseous species based on the first photothermal signal and the second photothermal signal comprises determining a difference between the first photothermal signal and the second photothermal signal.

In some embodiments, the determining the light absorption value of the gaseous species comprises determining the light absorption value of the gaseous species with filtered air in the sample region.

In some embodiments, the method further comprises tuning the at least one pump beam between the first wavelength and the second wavelength, wherein the first wavelength is on-resonance with the gaseous species and the second wavelength is off-resonance with the gaseous species.

In some embodiments, the method further comprises recalling the stored light absorption value for calibrating the measurement of aerosol absorption within the sample region, based on comparing the measurement of a particle-containing sample with that of a particle-free sample.

According to another aspect of the disclosure, there is provided a method of measuring aerosol absorption comprising: measuring light absorption of aerosol particles suspended in a gas in a sample region, the gas having a gaseous species; recalling a light absorption value of the gaseous species from memory, wherein the light absorption value is determined by: directing at least one pump beam to overlap with a probe beam in the gas in the sample region, wherein the at least one pump beam has a first wavelength that overlaps with an absorption line of the gaseous species, resulting in a first photothermal signal; directing the at least one pump beam to overlap a probe beam in the gas in the sample region, wherein the at least one pump beam has a second wavelength that is off the absorption line, resulting in a second photothermal signal; detecting the first photothermal signal and the second photothermal signal; and determining the light absorption value of the gaseous species based on the first light photothermal signal and the second light photothermal signal; and determining the light absorption of the aerosol particles, based on a comparison of the measurement of the light absorption of the aerosol particles suspended in the gas with the light absorption value of the gaseous species.

According to another aspect of the disclosure, there is provided a self-calibrating apparatus for measurement of aerosol absorption comprising: a photothermal spectrometer; at least one pump source disposed and configured to: direct at least one pump beam to overlap with a probe beam in a gas in a sample region, wherein the at least one pump beam has a first wavelength that overlaps with an absorption line of a gaseous species of the gas, resulting in a first photothermal signal; and direct the at least one pump beam to overlap with the probe beam in the gas in the sample region, wherein the at least one pump beam has a second wavelength that is off the absorption line, resulting in a second photothermal signal; a detector disposed and configured to detect the first photothermal signal and the second photothermal signal; a processor, operatively connected to the detector, configured to determine a light absorption value of the gaseous species based on the first photothermal signal and the second photothermal signal; and memory, operatively connected to the processor, for storing the light absorption value, for recalling in calibrating the measurement of aerosol absorption.

In some embodiments, the first wavelength is on-resonance with an absorption peak of the gaseous species.

In some embodiments, the at least one pump beam has a linewidth that is sufficiently narrow, relative to an absorption linewidth of the gaseous species, to tune the at least one pump beam on and off the absorption line.

In some embodiments, the at least one pump beam comprises s-polarized light and p-polarized light.

In some embodiments, the gaseous species is a narrow-band absorber having a known absorption cross-section.

In some embodiments, the processor being configured to determine a light absorption value of the gaseous species based on the first photothermal signal and the second photothermal signal comprises the processor being configured to determine a difference between the first photothermal signal and the second photothermal signal.

In some embodiments, the at least one pump source comprises at least one tunable excitation laser configured to tune the at least one pump beam between the first wavelength and the second wavelength, wherein the first wavelength is on-resonance with the gaseous species and the second wavelength is off-resonance with the gaseous species.

In some embodiments, the processor is further configured to, in response to recalling the light absorption value, calibrate the measurement of aerosol absorption in situ with the gas based on comparing the measurement of light absorption of aerosol particles suspended in the gas with the light absorption value of a gaseous species.

In some embodiments, the self-calibrating apparatus further comprises a folded Jamin interferometer that has an optical component that is partly-coated with beamsplitting coatings, high-reflective coatings, and anti-reflection coatings.

Other aspects and features of the disclosure will become apparent to those ordinarily skilled in the art upon review of the following description of specific embodiments of the disclosure.

### BRIEF DESCRIPTION OF THE DRAWINGS

Embodiments of the disclosure will now be described in greater detail with reference to the accompanying drawings, in which:

FIG. 1a illustrates a self-calibrating apparatus for measurement of aerosol absorption;

FIG. 1b illustrates a method of calibrating measurement of aerosol absorption;

FIG. 1c illustrates a method of measuring aerosol absorption;

FIG. 1d provides a view of a photothermal interferometry apparatus;

FIG. 1e is similar but using one excitation tunable-diode laser and optical element;

FIG. 2 provides a view of a folded-Jamin interferometer according to the prior art;

FIG. 3 is a graph illustrating a quadrature point of the photothermal interferometry apparatus of FIG. 1d or FIG. 1e;

FIG. 4 is a graph showing the calibration of the photothermal interferometry apparatus of FIG. 1d or FIG. 1e through modulating an excitation wavelength on and off resonance of a narrowband absorbing gas molecule; and

FIG. 5 is a graph showing the performance of the photothermal interferometry apparatus of FIG. 1d or FIG. 1e in comparison to that of a leading photoacoustic spectroscopy apparatus according to the prior art.

FIG. 6 illustrates an alternate photothermal interferometry apparatus using a chopping mirror (a mirrored beam chopper).

### DETAILED DESCRIPTION OF EMBODIMENTS

Various techniques were considered for measuring aerosol absorption.

U.S. Pat. No. 10,768,088 discloses photothermal interferometry using an axicon to modify a pump/excitation beam. The article entitled “Folded Jamin interferometer: a stable instrument for refractive-index measurements” by Moosmüller and Arnott discloses a folded-Jamin interferometer. The article entitled “A dual-wavelength photothermal aerosol absorption monitor: design, calibration and performance” by Drinovec et al. discloses a dual-beam photothermal interferometer and associated calibration method based on separate measurements of the refractive index of a nigrosine film. However, different refractive indices have been measured for nigrosine films and solutions measured under different circumstances. It also discloses a calibration method based on an external supply of nitrogen dioxide, NO₂. However, this requires a reliable reference measurement of the NO₂, as there can be a variability of up to 20% in manufacturer-supplied NO₂. These calibration methods both require reference samples of well-known compositions to be introduced to the instrument under controlled circumstances.

Most photothermal interferometers rely on probe and pump/excitation lasers. However the pump/excitation and probe functions can be provided by a single laser source as disclosed in the article entitled “A single-beam photothermal interferometer for in situ measurements of aerosol light absorption” by Visser et al. The single laser technique removes the need to align separate pump and probe lasers. However, this device precludes the use of lasers specialized to the pump and probe roles, as well as some calibration techniques which may require specific pump wavelengths.

Techniques for photoacoustic spectroscopy are disclosed in U.S. Pat. No. 7,710,566, and in the article entitled “Standard photoacoustic spectrometer: Model and validation using O₂ A-band spectra” by Gillis, Havey, and Hodges. In photoacoustic spectroscopy, the detection of aerosol absorption is achieved through the periodic heating of the sample to generate an excited sample, which then generates periodic pressure waves, or sound waves, via thermal relaxation. These waves are detected by a sensor placed at a distance from the sample. In one embodiment this may be a microphone at the wall of the sample cell. In the case of the Gillis et al. article, it was demonstrated that photoacoustic spectroscopy at the typical frequency of 1.6 kHz could not reliably detect oxygen molecules, since this frequency was similar in timescale to a confounding relaxation of oxygen in the presence of water, making that technique extremely sensitive to the humidity level.

Another technique for photoacoustic spectroscopy is disclosed in the article entitled “Simultaneous photoacoustic spectroscopy of aerosol and oxygen A-band absorption for the calibration of aerosol light absorption measurements” by Tian, Moosmüller, and Arnott, which proposed the combination of photoacoustic spectroscopy and wavelength modulation spectroscopy in a single instrument cell, to calibrate a photoacoustic instrument. Wavelength modulation spectroscopy involves the modulation of the wavelength of a pump laser, in order to repeatedly reference the narrow-band absorption of a gas molecule to a nearby baseline region. Since photoacoustic and wavelength modulation spectroscopy are two distinct techniques, they each operate based on different physical principles, generate signals of a different physical nature, are detected at different physical locations, and are performed at different timescales. Therefore, the calibration described by Tian et al. is indirect.

Each of the above techniques do not permit traceably quantifying aerosol absorption. Rather, they rely on indirect calibrations. As discussed in more detail below, embodiments of the present disclosure involve one technique with no change to the setup, making the calibration direct.

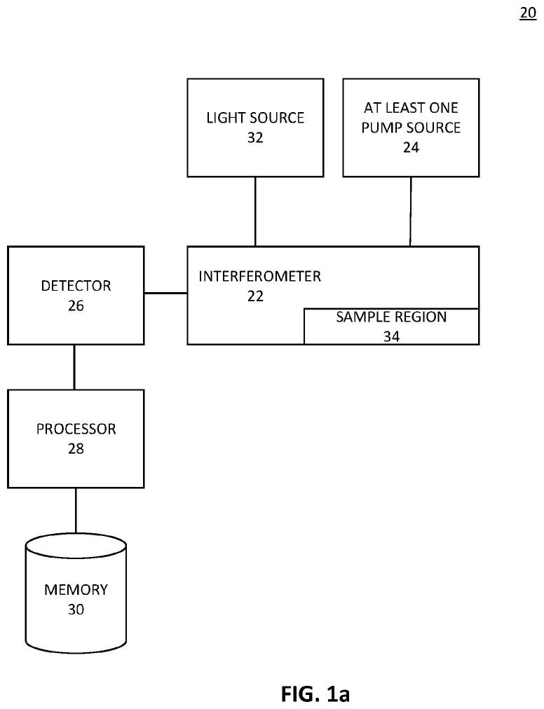

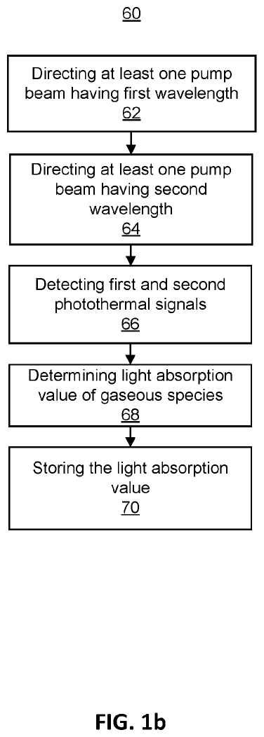

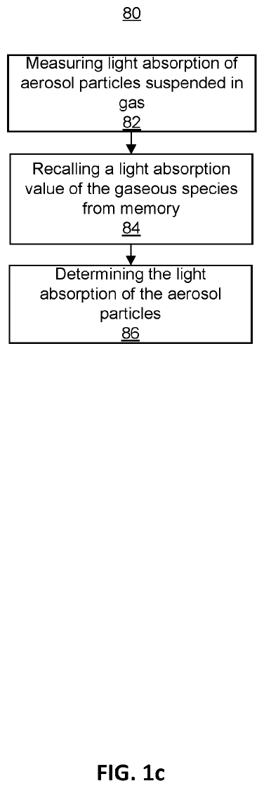

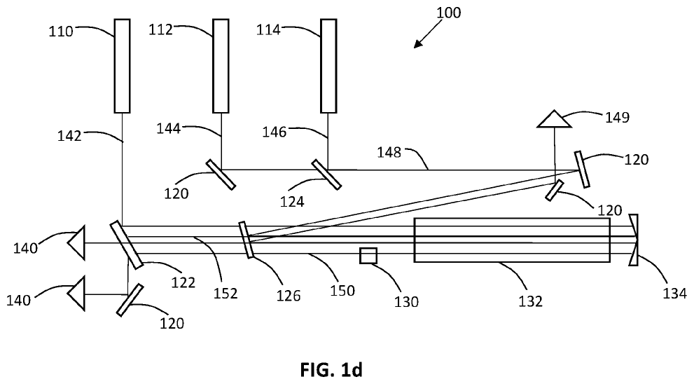

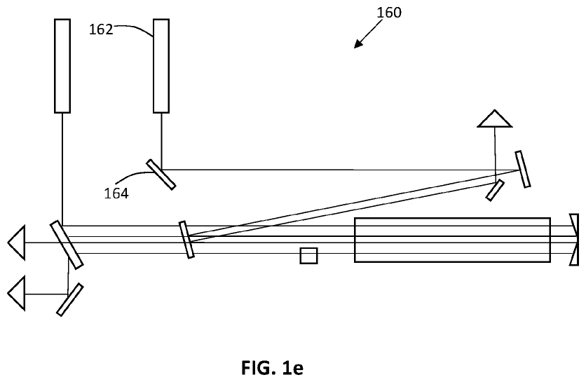

FIG. 1a illustrates a self-calibrating apparatus for measurement of aerosol absorption, according to one or more embodiments.

The self-calibrating apparatus 20 may include a photothermal interferometer 22, at least one pump (excitation) source 24, detector 26, processor 28, memory 30, a light source 32, and a sample region 34.

The photothermal interferometer 22 includes a folded Jamin interferometer that has an optical component that is partly-coated with beamsplitting coatings, high-reflective coatings, and anti-reflection coatings. The photothermal interferometer 22 may receive a light beam from a light source 32 and split the light beam into two beams, which together form the interferometer 22 upon combination. One interferometer beam may be used as the probe beam and the other as a reference beam.

The pump source 24 may be disposed and configured to direct at least one pump (excitation) beam to overlap with an interferometer beam in a gas in the sample region 34. The pump beam may be generated from a laser with a first wavelength that is tunable, such that its wavelength may be in resonance with an absorption line of a gaseous species. The pump beam may result in a first photothermal signal, if the light absorption results in sample heating and a change in the optical path length in the probe beam. This photothermal signal may be stored in memory.

The pump source 24 may be further disposed and configured to direct the pump beam to overlap with the interferometer beam in the gas in the sample region 34. The pump beam may have a second wavelength that is off the absorption line. This may result in a second photothermal signal. Alternatively, the first wavelength may be tuned to be off the absorption line while the second wavelength may be tuned to be on the absorption line of the gas in the sample region 34.

The first wavelength may be on-resonance with an absorption peak of the gaseous species. The pump beam may have a linewidth that is sufficiently narrow, relative to an absorption linewidth of the gaseous species, to tune the pump beam on the absorption line. The gaseous species may be a narrow-band absorber having a known absorption cross-section. The gaseous species may be diatomic oxygen.

The pump source 24 may comprise at least one tunable pump laser configured to tune the at least one pump beam between the first wavelength and the second wavelength, wherein the first wavelength is on-resonance with the gaseous species and the second wavelength is off-resonance with the gaseous species. In an example, the pump source 24 may be multiple tunable pump (excitation) lasers. The use of multiple tunable pump lasers may allow for lower power pump lasers to be used in the interferometer. In one such example, the at least one pump beam may comprise an s-polarized pump laser and a p-polarized pump beam overlapped with one another to provide an effectively stronger pump source 24. In another example, the pump source 24 may be fixed pump lasers in that each is fixed to a first wavelength, second wavelength, or other fixed wavelengths.

The detector 26 may be disposed and configured to detect the first photothermal signal and the second photothermal signal. The detector 26 may be a light-sensitive detector or a phase sensitive detector or detection method.

The processor 28 may be operatively connected to the detector 26. The processor 28 may be configured to determine a light absorption value of the gaseous species based on the first photothermal signal and the second photothermal signal. In an example, the processor 28 may determine a difference between the first photothermal signal and the second photothermal signal. In another example, the processor 28 may subtract the second photothermal signal from the first photothermal signal. The processor 28 may be further configured to, in response to recalling the light absorption value, calibrate the measurement of aerosol absorption in situ with the gas based on comparing the measurement of light absorption of aerosol particles suspended in the gas with the light absorption value.

The memory 30 may be operatively connected to the processor 28. The memory 30 may store the light absorption value, for recalling in calibrating the measurement of aerosol absorption.

FIG. 1b illustrates a method 60 of calibrating measurement of aerosol absorption, according to one or more embodiments.

Step 62 may include directing at least one pump beam to overlap with an interferometer beam in a gas in a sample region, wherein the at least one pump beam has a first wavelength that overlaps with an absorption line of a gaseous species of the gas, resulting in a first photothermal signal.

Step 64 may include directing the pump beam into a sample region, wherein the pump beam may have a second wavelength near to or far from an absorption line of a gas molecule. This pump beam may result in heating of the sample volume along the pump beam. This heating would result in a change of the refractive index of the sample volume. This change may, for example, be detected by overlapping one arm of an interferometer with the pump beam. This arm would generate a change in photothermal signal due to the heating of the sample volume.

Step 66 may include detecting the first photothermal signal under a first set of conditions and the second photothermal signal under a second set of conditions.

Step 68 may include determining a light absorption value of the gaseous species based on the first photothermal signal and the second photothermal signal.

Step 70 may include storing the light absorption value, for recalling in calibrating the measurement of aerosol absorption.

FIG. 1c illustrates a method 80 of measuring aerosol absorption, according to one or more embodiments.

Step 82 may include measuring light absorption of aerosol particles suspended in a gas in a sample region, the gas having a gaseous species.

Step 84 may include recalling a light absorption value of the gaseous species from memory, wherein the light absorption value is determined by the method 60.

Step 86 may include determining the light absorption of the aerosol particles, based on a comparison of the measurement of the light absorption of the aerosol particles suspended in the gas with the light absorption value of the gaseous species.

This permits measurement of wavelength-dependent absorption, not only absorption at a single wavelength. Wavelength-dependent absorption can be measured by varying the wavelength of the pump laser, or replacing it with another laser, and measuring the power of each laser with standard methods.

A specific embodiment is now described. A photothermal interferometer, using a pump laser of tunable wavelength and a detection scheme based on interferometry, can be used to measure light absorption of an aerosol, characterized by the suspension of particles in a gas, within a sample region. The wavelength of the tunable pump laser can be adjusted to overlap with a specific rovibronic absorption line of a gaseous species, or gas molecule, such as that of diatomic oxygen. The known concentration and known absorption cross-section of the gas molecule allows for a single-point calibration of the photothermal interferometer. The calibration can be performed regardless of the presence of any absorbing particles, as particles are broadband absorbers. It permits in-situ calibration of aerosol absorption measurements. Further advantages include the ability to detect the absorption of aerosols and nanoparticles from samples in the field, and a more efficient calibration process that can be performed in the field, without the use of separate reference samples.

FIG. 1d illustrates a photothermal interferometry apparatus 100 according to one or more embodiments. In some embodiments, the photothermal interferometry apparatus 100 may be configured to detect aerosols in a gas in a laboratory environment or it may be transportable in order to detect aerosols in a gas at the location where samples of the gas are acquired.

The photothermal interferometry apparatus 100 comprises an interferometry laser 110 and two pump lasers 112, 114 to provide light beams, several optical elements 120 for directing the light beams, a custom folded-Jamin beam splitter 122, a polarizing beam splitter or combiner 124, a dichroic mirror 126, a pressure cell 130, a sample cell 132, a retroreflector 134, and several detectors 140. The custom folded-Jamin beam splitter 122 and the retroreflector 134 form a custom folded-Jamin interferometer 200.

The interferometry laser 110 may also be referred to as a probe laser. The interferometry laser 110 is a laser with a relatively low output power, such as a Helium-Neon (He—Ne) laser. The interferometer laser 110 is not required to have a high optical output power, and operates with an output power of approximately 1 mW. Using a low optical output power laser such as a He—Ne laser, that operates with an output power of less than tens or hundreds of mW, for interferometry is advantageous as the chemical and physical properties of the aerosols to be studied will not be altered by a transfer of energy from the interferometry laser 110. The interferometry laser 110 operates at any wavelength convenient for interferometry, such as with a radiation wavelength of 632.8 nm, which corresponds to red light. A He—Ne laser has a long coherence length which is ideal for interferometry as the photons that are emitted are substantially in phase. The He—Ne laser also provides a sharp frequency distribution with a constant power output. The He—Ne laser is a preferred candidate for an interferometry laser 110 as it provides precise measurements due to its mode purity, frequency, and intensity stability. The He—Ne interferometry laser 110 used in the preferred embodiment is a thermally stabilized laser source that is commercially available. The interferometry laser 110 provides an interferometry beam 142.

The pump lasers 112, 114 may also be referred to as excitation lasers. The pump lasers 112, 114 are wavelength tunable diode lasers with a higher output power than that of the interferometry laser 110. The output power of the pump lasers 112, 114 is approximately 80 mW, with an excitation wavelength of 761 nm. Wavelength tunable lasers are used in order for them to be able to be tuned on or off a narrow-band absorption band of a specific gas molecule, such as a small gas molecule. Diatomic oxygen (O₂) is a suitable narrow-band absorption gas molecule. This tuning creates an additional signal associated with the molecular absorption band, which is known from prior work, and along with the concentration of the gas molecule, can be used to calibrate the photothermal interferometry apparatus 100. The pump lasers 112, 114 are preferably lasers with sufficiently narrow linewidth, in comparison with gaseous absorption linewidth, in order to enable tuning of the pump lasers 112, 114 wavelength to be off-and on-resonant of the narrow-band absorption gas molecule for measurement of absorption due to aerosols, which are typically broad-band absorbers. One pump laser 112 provides an s-polarized light beam 144, and the other pump laser 114 provides a p-polarized light beam 146. The s-polarized light beam 144 and the p-polarized light beam 146 are in different planes that are combined at the polarized beam splitter 124 to provide a single light beam 148 with a higher power. The pump lasers 112, 114 provide the p-polarized light beam 146 and the s-polarized light beam 144 respectively, that when combined provide a pump beam 148.

The photothermal interferometry apparatus 100 includes several optical elements 120 which are mirrors for directing the light beams 142, 148 outputted from the interferometry laser 110 and the pump lasers 112, 114. The light beams 142, 148 are directed to overlap and to pass through a sample cell 132 with a gas to be analyzed.

The photothermal interferometry apparatus 100 includes a dichroic mirror 126. The dichroic mirror 126 acts as a window for the interferometry beam and as a mirror for the pump beam. The dichroic mirror 126 directs the light beams from the interferometry laser 110 and the pump lasers 112, 114 towards and through the sample cell 132. Once the light beams have passed through the sample cell 132, the dichroic mirror 126 directs only the pump beam 148 to a power meter 149. The power meter is used to account for any variability in power due to the wavelength tuning of the pump beam 148.

The photothermal interferometry apparatus 100 includes an interferometer 200, such as an optical interferometer like a custom folded-Jamin interferometer. A folded-Jamin interferometer is described in the scientific journal article entitled “Folded Jamin interferometer: a stable instrument for refractive-index measurements” by Moosmüller and Arnott, published in Optics Letters in March 1996.

FIG. 1e is similar to FIG. 1d but using a single tunable-diode pump laser 162 and optical element 164 in a photothermal interferometry apparatus 160. The single pump laser arrangement of FIG. 1e can be used when a sufficiently powerful individual pump laser 162 is available, obviating the need to use multiple overlapped pump lasers 112, 114 as described above in respect of the arrangement in FIG. 1d.

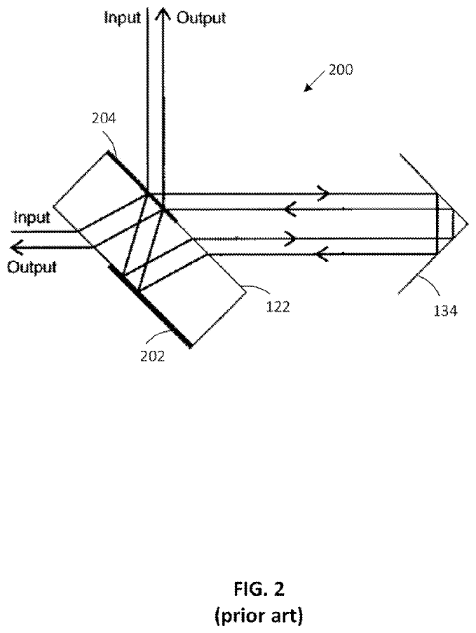

With reference to FIG. 2, the folded-Jamin interferometer 200 comprises a partially reflective mirror for splitting a light beam into two light beams. The custom folded-Jamin interferometer 200 creates the two beams with a custom-made optical component, and the retroreflector 134. The custom-made optical component is at least partially coated with a beam splitting coating 204, a highly reflective coating 202, and may include an anti-reflection coating and works in conjunction with a retroreflector 134. The custom folded-Jamin interferometer 200 comprises four optical components: two beam splitters and two mirrors. These are housed on one optical slab, which reduces the sensitivity of the interferometer 200 to mechanical perturbations, vibrations, and other environment effects. The use of the retroreflector 134 reduces the risk of misalignment, such as those caused by physical vibrations, as the retroreflector 134 reflects the light beams 142, 148 in parallel to the incoming beam and its in-plane rotational perturbations do not affect the alignment. These two components of the custom folded-Jamin interferometer 200 result in a robust interferometer 200 with minimal mechanical degrees of freedom, and in which the alignment does not require frequent checking, making it suitable for transportation and setup in the field.

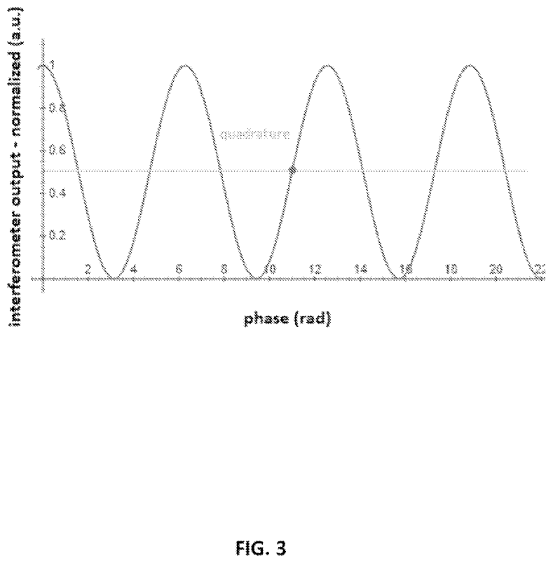

The photothermal interferometry apparatus 100 further includes a pressure cell 130. The most sensitive operation condition of the interferometer 200 is known as the quadrature point. The interferometer 200 is maintained at the quadrature point by the pressure cell 130. The quadrature point, shown in FIG. 3, is a midway point between complete constructive and complete destructive interference conditions, and the interferometer 200 shows the largest intensity variation with respect to a change of phase at the quadrature point. That arm of the interferometer, which is not shared by the pump laser beam, was selected for the pressure cell 130. The pressure cell 130 is applied to the reference beam 150, which is not overlapped with the pump beam 148. The pressure within the pressure cell 130 is controlled by a pressure controller connected to a source of compressed air (not shown). A proportional-integral-differential (PID) feedback loop is used to control the pressure of the pressure cell 130 to maintain the interferometer 200 at the quadrature point by compensating for the change in refractive index. This PID loop operates at a much slower timescale than the modulation timescale of the pump laser. As such, the PID loop can help to compensate for possible changes in refractive index caused by changes in the ambient environment such as air pressure or ambient temperature.

The output of the interferometer 200 is detected at either or both outputs of the interferometer 200 by light-sensitive detectors 140, such as photodiodes, which detect the output light intensity. The detectors 140 are configured to sense the light intensity and provide a signal which is sent to a lock-in amplifier (not shown). The lock-in amplifier is configured with a reference frequency that is equal to a modulation frequency of the pump lasers 112, 114. The output of the lock-in amplifier is not sensitive to phase and is configured to provide the output photothermal interferometry signal that can be analyzed to determine the light absorption of aerosols in the gas sample.

The calibration process for an embodiment of the present disclosure can be achieved with the photothermal interferometry apparatus 100 at the location where gas samples are to be tested, providing an advantage over the current state-of-the-art that rely on reference cells, laboratory calibration, or two-stage calibration methods. A further advantage of the calibration process is that it is independent of the type of interferometer, or other detection scheme, used.

The interferometry laser 110 is aligned so that the interferometry beam 142 is directed by the custom folded-Jamin beam splitter 122 and retroreflector 134 to provide a plurality of directed beams within the sample cell 132, including the reference beam 150 and the probe beam 152. The pump beam 148 is directed by a mirror 120 towards the dichroic mirror 126 and is overlapped with the probe beam 152 and directed through the sample cell 132, heating the gas sample. The overlapped probe beam 152 and pump beam 148 may be separated using the same dichroic mirror 126 or another dichroic mirror, before or after reflection off the retroreflector 132. The probe beam 152 is then combined with the other arm of the interferometer 152 and one or both of the resulting two combined beams are directed using mirrors 120 towards detectors 140.

The photothermal interferometry apparatus 100 is calibrated in-situ through the tuning of the pump lasers 112, 114. The in-situ calibration method depends on the ability to tune the pump laser wavelength to be off-resonant and on-resonant with a known absorption peak of a gas molecule present at a known concentration. The wavelength of the pump lasers 112, 114 is modulated at a controlled frequency, for example, through the adjustment of the injection current to the pump lasers 112, 114.

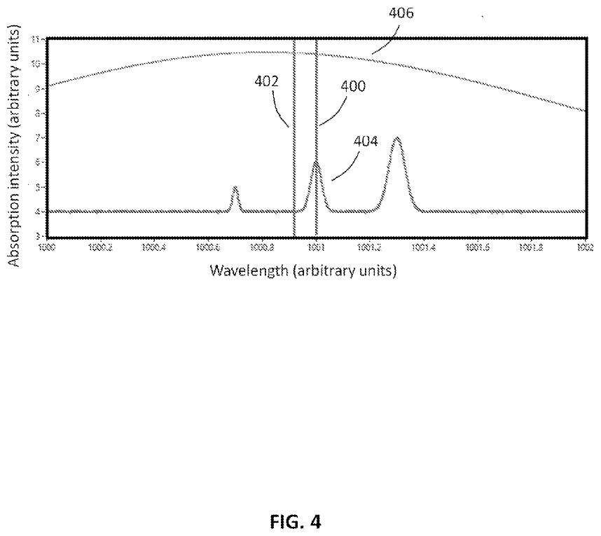

With reference to FIG. 4, the modulation of the wavelength of the pump lasers 112, 114 within a range that is on-resonance 400 and off-resonance 402 with a known absorption peak of a gas molecule is shown. The gas molecule preferably is a narrow-band absorber 404 having a narrow absorption band. The aerosol nanoparticles being detected typically are broadband absorbers 406 with a broad absorption band, making a gas molecule with a narrow absorption band ideal for the calibration process.

Diatomic oxygen, O₂, is a convenient gas molecule for the calibration process as it is present in almost all air samples, and at a known concentration of 20%. Diatomic oxygen also has a relatively simple and well understood absorption spectrum. By tuning the pump lasers 112, 114 on and off resonance with the diatomic oxygen, a signal is generated that corresponds to the absorption spectrum of the diatomic oxygen. The absorption spectrum is then extracted from a scientific database such as the High Resolution Transmission Absorption Database (HITRAN), the High-Temperature Molecular Spectroscopic Database (HITEMP), GEISA, or similar. The modulation frequency of the pump lasers 112, 114 is used in the detection stage to extract the signal from the output of the interferometer 200, at the same modulation frequency or at multiples of the modulation frequency. The calibration process may be performed on diatomic oxygen, which allows for accurate calibration to be performed. The calibration process may be performed at any time while the photothermal interferometry apparatus 100 is operating, for example, at intervals of from about one minute up to several hours. The interval may be chosen based on the instrument, sample and the field conditions.

The probe beam 152 measures changes in the refractive index of the sample cell due to the photothermal effect induced by the pump beam. The photothermal effect proceeds as follows. The pump beam 148 heats the gas in the sample cell along the path of the pump beam 148, and as the refractive index of gas is dependent on temperature, the refractive index along the pump beam 148 path changes. As a result, the probe beam 152, which overlaps with the pump beam 148, and the reference beam 150 travel different optical paths. The different optical paths travelled manifests as a detectable change in phase.

Overlapping the pump beam 148 with the probe beam 152 and directing them through the sample cell 132, when the pump beam 148 is on-resonance with the gas molecule, results in a photothermal signal. Overlapping the pump beam 148 with the probe beam 152 and directing them through the sample cell 132, when the pump beam 148 is off-resonance with the gas molecule, results in another, different photothermal signal. Determining the light absorption of the gas molecule based on the two photothermal signals allows for calibration of the measurement of aerosol absorption.

In contrast to the narrowband gaseous absorber, the aerosol samples to be used with this instrument are broadband absorbers due to their solid or liquid chemical states. The total signal generated by the photothermal interferometry apparatus 100 comprises a background signal, a gas molecule signal, and an aerosol-particle signal. The background signal is determined by measuring a particle-free (filtered) air sample, with the pump laser tuned to an off-resonance wavelength. The background signal can also be determined by measuring a particle-free (filtered) gas sample comprising a gas free of absorbing gaseous species, such as purified nitrogen. The gas molecule signal is determined by tuning the laser. The aerosol-particle signal is then the only unknown. The off-resonance and on-resonance measurement of the photothermal interferometry signals with filtered air in the sample cell provides a reference for the in-situ calibration of light-absorbing aerosols.

According to one or more embodiments, the pump beam 148 is capable of operating with at least two wavelengths. The pump beam 148 is directed to overlap with the probe beam 152 in the gas. The first wavelength overlaps with an absorption line of a gaseous species and the second wavelength does not.

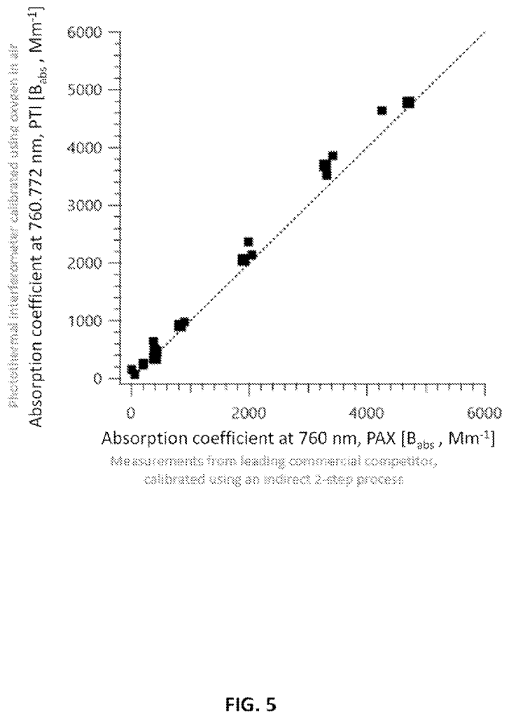

With reference to FIG. 5, the performance of a prototype of the photothermal interferometry apparatus 100 was calibrated using oxygen in air and is shown (y-axis) in comparison to a Photoacoustic Extinctiometer (PAX) apparatus from Droplet Measurement Technologies Inc., which was calibrated using an indirect 2-step process (x-axis). The amount of light absorption is shown in terms of the absorption coefficient, in units of inverse length (b_{abs}, Mm⁻¹). This aerosol absorption coefficient is comparable between the two apparatus setups, therefore the photothermal interferometry apparatus 100 is able to detect the absorption of aerosols in gas, having been calibrated using diatomic oxygen. Using diatomic oxygen as the calibrant does not negatively affect the performance of the photothermal interferometry apparatus 100.

Although in the embodiments described above, the interferometry laser 110 is a He—Ne laser, in other embodiments a different laser may be used. Any laser with suitable characteristics, such as a long coherence length, a sharp frequency distribution, and a constant power output, could be used. A diode laser, or any other light source, that allows optical interferometry may also be used.

Although in the embodiments described above, two pump lasers 112, 114 are used to heat the sample, a single high power pump laser may be used. If the pump laser is of too high a power, it may heat the sample enough to evaporate volatile components of the aerosols to be detected.

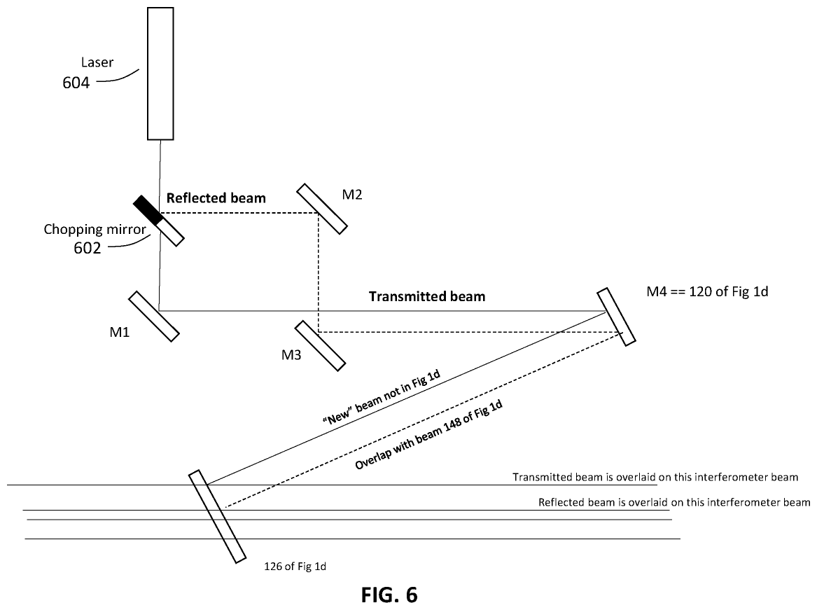

Although in the embodiments described above, two pump lasers 112, 114 are used to heat the sample, the pump laser power may effectively be doubled by the use of a chopping mirror. Such a chopping mirror may periodically deflect the pump laser beam onto a different path by rotating or sliding in and out of the beam path. FIG. 6 shows such an embodiment. A chopping mirror 602 either transmits or reflects a laser 604 which is continuously on. When transmitted, the pump laser is sent to one arm of the interferometer (either the beam that was reflected or transmitted at the first beamsplitter surface) using mirrors [M1] and [M4]. When reflected, the pump laser is sent to the other arm using mirrors [M2, M3, and M4]. Thus, the two arms receive power in an out-of-phase pattern. This causes the temperature difference between the arms to be doubled relative to the simple case of a single beam pumping one arm of the interferometer. Therefore, the useful signal of the instrument is doubled without a need for any additional laser power.

Although in the embodiments described above, an interferometer 200 is used to detect the photothermal signal, other detection schemes can be used. For example, an optical heterodyne may be used to detect the photothermal signal.

Although in the embodiments described above, the wavelength of the pump lasers 112, 114 is modulated at a controlled frequency by controlling the injection current, other methods are possible. For example, the pump lasers 112, 114 could be modulated with the use of a mechanical chopper.

Although in the embodiments described above, a custom folded-Jamin interferometer 200 is used, a different interferometer may be used for photo-thermal interferometry. Different interferometers may operate based on detection of intensity or phase of the interfering beams.

Although in the embodiments described above, a dichroic mirror 126 is placed outside of the sample cell 132, two dichroic mirrors may be used to provide two windows in the sample cell. The first mirror may be used to overlap the pump and interferometer laser beams, while the second mirror may be used to separate the two beams. Thus, the two beams only overlap, and generate signal, within the sample cell. This may reduce the generation of spurious signals from absorbing gases or particles outside of the sample cell.

Although in the embodiments described above, a pressure cell 130 is used to maintain the interferometer at the quadrature point, other methods may be used such as by moving a mirror attached to a piezo translational stage, or by controlling a polarization vector of light.

Although in the embodiments described above, photo-diodes are used as the light-sensitive detectors 140, other detectors may be used such as photomultiplier tubes or avalanche photodiodes or similar.

Although in embodiments described above, the absorption spectrum of the calibrant used is extracted from an appropriate scientific database, other methods may be used. For example, for a calibrant that is not included in such scientific databases, an absorption cross-section can be determined experimentally for a given gas concentration, temperature, and pressure.

The device and calibration method described could be used to provide comparison data for the calibration of other monitoring instruments and research instruments, and instruments relying on the measurement of aerosol absorption. For example, the calibration of aerosol absorption instruments used in climate monitoring stations, calibrating LIDAR measurements, and for satellite measurements of aerosols. Accurate calibration of aerosol absorption measurements is vital for understanding the role that aerosols play in affecting climate change, and for determining the emissions signature of engines such as those in aircraft, marine vehicles, and ground transportation vehicles. The photothermal interferometry apparatus 100 may be used in applications such as the quantification of air pollution from combustion in relation to aviation and automotive emissions regulation and epidemiology; monitoring of climate change/warming; and can be adapted for use in nanotechnology such as in relation to flame synthesis and microwave reactors. The photothermal interferometry apparatus 100 permits traceable measurement of aerosol absorption. The photothermal interferometry apparatus 100 may be used as a portable calibration standard to calibrate other instruments in laboratories, monitoring sites, emissions measurement sites, and similar.

The photothermal spectroscopy apparatus 100 may also incorporate any additional pump laser. Additional lasers may be overlapped with the pump laser by aligning them to produce the maximum photothermal signal, which indicates optimal overlap. The photothermal signal generated by such additional lasers may be normalized to the pump laser based on the beam diameter and average power density of those lasers, as measured according to standard techniques in the art.

The performance and cost-of-components of the photothermal interferometry apparatus 100 is comparable to existing commercial instruments. The photothermal interferometry apparatus 100 can be improved for greater sensitivity and to measure other physical properties of the aerosol simultaneously (e.g., light-scattering). It can be a primary measurement of aerosol absorption and also be competitive with existing commercial instruments. The sensitivity of the photothermal interferometry apparatus 100 is in line with less sensitive commercial instruments, however the most sensitive commercial instruments, that claim much higher sensitivities, cannot be accurately and directly calibrated and are therefore not suitable for metrological applications. A limitation in aerosol absorption measurement is accuracy. The photothermal interferometry apparatus 100 uses oxygen in air as an internal calibrant, allowing accurate calibration to be performed every minute.

What has been described is merely illustrative of the application of the principles of the disclosure. Other arrangements and methods can be implemented by those skilled in the art without departing from the scope of the disclosure.

As used herein, an element or feature introduced in the singular and preceded by the word “a” or “an” should be understood as not necessarily excluding the plural of the elements or features. Further, references to “one example” or “one embodiment” are not intended to be interpreted as excluding the existence of additional examples or embodiments that also incorporate the described elements or features. Reference herein to “example” means that one or more feature, structure, element, component, characteristic and/or operational step described in connection with the example is included in at least one embodiment and/or implementation of the subject matter according to the subject disclosure. Thus, the phrases “an example,” “another example” and similar language throughout the subject disclosure may, but do not necessarily, refer to the same example. Further, the subject matter characterizing any one example may, but does not necessarily, include the subject matter characterizing any other example.

Unless explicitly stated to the contrary, examples or embodiments “comprising” or “having” or “including” an element or feature or a plurality of elements or features having a particular property may include additional elements or features not having that property. Also, it will be appreciated that the terms “comprises”, “has”, “includes” means “including but not limited to” and the terms “comprising”, “having” and “including” have equivalent meanings.

As used herein, the term “and/or” can include any and all combinations of one or more of the associated listed elements or features.

It will be understood that when an element or feature is referred to as being “on”, “attached” to, “affixed” to, “connected” to, “coupled” with, “contacting”, etc. another element or feature, that element or feature can be directly on, attached to, connected to, coupled with or contacting the other element or feature or intervening elements may also be present. In contrast, when an element or feature is referred to as being, for example, “directly on”, “directly attached” to, “directly affixed” to, “directly connected” to, “directly coupled” with or “directly contacting” another element of feature, there are no intervening elements or features present.

It will be understood that spatially relative terms, such as “under”, “below”, “lower”, “over”, “above”, “upper”, “front”, “back” and the like, may be used herein for ease of description to describe the relationship of an element or feature to another element or feature as illustrated in the figures. The spatially relative terms can however, encompass different orientations in use or operation in addition to the orientation depicted in the figures.

Reference herein to “configured” denotes an actual state of configuration that fundamentally ties the element or feature to the physical characteristics of the element or feature preceding the phrase “configured to.”

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of a lower-numbered item (e.g., a “first” item) and/or a higher-numbered item (e.g., a “third” item).

As used herein, the terms “approximately” and “about” represent an amount close to the stated amount that still performs the desired function or achieves the desired result. For example, the terms “approximately” and “about” may refer to an amount that is within engineering tolerances that would be readily appreciated by a person skilled in the art. Although embodiments have been described above with reference to the accompanying drawings, those of skill in the art will appreciate that variations and modifications may be made without departing from the scope thereof as defined by the appended claims.

1. A method of calibrating measurement of aerosol absorption comprising:
directing at least one pump beam to overlap with a probe beam in a gas in a sample region, wherein the at least one pump beam has a first wavelength that overlaps with an absorption line of a gaseous species of the gas, resulting in a first photothermal signal;
directing the at least one pump beam to overlap with the probe beam in the gas in the sample region, wherein the at least one pump beam has a second wavelength that is off the absorption line, resulting in a second photothermal signal;
detecting the first and second photothermal signals;
determining a light absorption value of the gaseous species based on the first and second photothermal signals; and
storing the light absorption value, for recalling in calibrating the measurement of aerosol absorption by a third photothermal signal.

2. The method of claim 1, wherein the first wavelength is on-resonance with an absorption peak of the gaseous species.

3. The method of claim 1, wherein the at least one pump beam has a linewidth that is sufficiently narrow, relative to an absorption linewidth of the gaseous species, to tune the at least one pump beam on or off the absorption line.

4. The method of claim 1, wherein the gaseous species is a narrow-band absorber having a known absorption cross-section.

5. The method of claim 1, wherein the gaseous species is diatomic oxygen.

6. The method of claim 1, wherein the detecting the first and second photothermal signals is based on interferometric detection or optical heterodyne detection.

7. The method of claim 1, wherein the determining the light absorption value of the gaseous species based on the first photothermal signal and the second photothermal signal comprises determining a difference between the first photothermal signal and the second photothermal signal.

8. The method of claim 1, wherein the determining the light absorption value of the gaseous species comprises determining the light absorption value of the gaseous species with filtered air in the sample region.

9. The method of claim 1, further comprising tuning the at least one pump beam between the first wavelength and the second wavelength, wherein the first wavelength is on-resonance with the gaseous species and the second wavelength is off-resonance with the gaseous species.

10. The method of any one of claim 1, further comprising recalling the stored light absorption value for calibrating the measurement of aerosol absorption within the sample region, based on comparing the measurement of a particle-containing sample with that of a particle-free sample.

11. The method of claim 1, further comprising a chopping mirror arranged to periodically deflect the at least one pump beam.

12. A method of measuring aerosol absorption comprising:
measuring light absorption of aerosol particles suspended in a gas in a sample region, gas having a gaseous species;
recalling a light absorption value of the gaseous species from memory, wherein the absorption value is determined by:
directing at least one pump beam to overlap with a probe beam in the gas in the sample region, wherein the at least one pump beam has a first wavelength that overlaps with an absorption line of the gaseous species, resulting in a first photothermal signal;
directing the at least one pump beam to overlap a probe beam in the gas in the sample region, wherein the at least one pump beam has a second wavelength that is off the absorption line, resulting in a second photothermal signal;
detecting the first photothermal signal and the second photothermal signal; and
determining the light absorption value of the gaseous species based on the first light photothermal signal and the second light photothermal signal; and
determining the light absorption of the aerosol particles, based on a comparison of the measurement of the light absorption of the aerosol particles suspended in the gas with the light absorption value of the gaseous species.

13. A self-calibrating apparatus for measurement of aerosol absorption comprising:
a photothermal spectrometer;
at least one pump source disposed and configured to:
direct at least one pump beam to overlap with a probe beam in a gas in a sample region, wherein the at least one pump beam has a first wavelength that overlaps with an absorption line of a gaseous species of the gas, resulting in a first photothermal signal; and
direct the at least one pump beam to overlap with the probe beam in the gas in the sample region, wherein the at least one pump beam has a second wavelength that is off the absorption line, resulting in a second photothermal signal;
a detector disposed and configured to detect the first photothermal signal and the second photothermal signal;
a processor, operatively connected to the detector, configured to determine a light absorption value of the gaseous species based on the first photothermal signal and the second photothermal signal; and
memory, operatively connected to the processor, for storing the light absorption value, for recalling in calibrating the measurement of aerosol absorption.

14. The self-calibrating apparatus of claim 13, wherein the first wavelength is on-resonance with an absorption peak of the gaseous species.

15. The self-calibrating apparatus of claim 13, wherein the at least one pump beam has a linewidth that is sufficiently narrow, relative to an absorption linewidth of the gaseous species, to tune the at least one pump beam on and off the absorption line.

16. The self-calibrating apparatus of claim 13, wherein the at least one pump beam comprises s-polarized light and p-polarized light.

17. The self-calibrating apparatus of claim 13, wherein the gaseous species is a narrow-band absorber having a known absorption cross-section.

18. The self-calibrating apparatus of claim 13, wherein the processor being configured to determine a light absorption value of the gaseous species based on the first photothermal signal and the second photothermal signal comprises the processor being configured to determine a difference between the first photothermal signal and the second photothermal signal.

19. The self-calibrating apparatus of claim 13, wherein the at least one pump source comprises at least one tunable pump laser configured to tune the at least one pump beam between the first wavelength and the second wavelength, wherein the first wavelength is on-resonance with the gaseous species and the second wavelength is off-resonance with the gaseous species.

20. The self-calibrating apparatus of claim 13, wherein the processor is further configured to, in response to recalling the light absorption value, calibrate the measurement of aerosol absorption in situ with the gas based on comparing the measurement of light absorption of aerosol particles suspended in the gas with the light absorption value of a gaseous species.

20. The self-calibrating apparatus of claim 13, further comprising a folded Jamin interferometer that has an optical component that is partly-coated with beamsplitting coatings, high-reflective coatings, and anti-reflection coatings.

22. The self-calibrating apparatus of claim 13, further comprising a chopping mirror arranged to periodically deflect the at least one pump beam.
